(19) United States
(12) Patent Application Publication
(10) Pub. No.: US 2025/0001695 A1
(43) Pub. Date: Jan. 2, 2025

(54) RAPID PRODUCTION OF SPARE PARTS WITH DYNAMICALLY CREATED MOLDS WITH PHOTOSENSITIVE MATERIAL

(71) Applicant: International Business Machines Corporation, Armonk, NY (US)

(72) Inventors: Sarbajit K. Rakshit, Kolkata (IN); Manikandan Padmanaban, Chennai (IN); Jagabondhu Hazra, Bangalore (IN)

(21) Appl. No.: 18/342,804

(22) Filed: Jun. 28, 2023

(51) Int. Cl. B29C 64/393; B29C 64/118

(52) U.S. Cl. CPC B29C 64/393; B29C 64/118; B33Y 10/00; B33Y 50/02

(57) ABSTRACT

In an approach for manufacturing a spare part with rapid speed, a processor identifies a spare part to be manufactured. A processor gathers a set of data regarding one or more properties of the spare part. A processor determines the spare part can be manufactured using a casting process. A processor determines a photosensitive resin can be used to make a mold in which an individual part of the spare part will be manufactured. A processor creates an ultraviolet (UV) ray based holographic model of the individual part. A processor projects the UV ray based holographic model of the individual part on the photosensitive resin. A processor enables the photosensitive resin to solidify to create a mold of the individual part. A processor dynamically creates a production line to assemble one or more molds of one or more individual parts of the spare part.

### BACKGROUND OF THE INVENTION

The present invention relates generally to the field of parts production, and more particularly to a rapid production of a spare part with a dynamically created mold with photosensitive material.

Photosensitive material is made up of polymers that can undergo rapid physical and chemical changes in a relatively short period of time after being irradiated by light. Photosensitive material is advanced by high production efficiency, high energy utilization rate, low organic volatile matter emission, and enhanced flexibility in coating various substrates, such as paper, plastic, leather, metal, glass, and ceramics. Photosensitive resin, a type of photosensitive material, is widely used in medical, construction, manufacturing, packaging, and other industries due to the fast-curing time and low pollution of the photosensitive resin.

Manufacturing is the assembly of finished goods for sale or use from raw materials. The assembly of finished goods may occur using manual labor or robotic automation and is typically carried out systemically with a division of labor. Robotic automation systems are utilized in manufacturing to assemble, disassemble, package and label, palletize, inspect, and test products. Robotic automation systems use sensors and sensor fusion components to function. Robotic automation systems pick products off conveyor belts and place them in a desired location. Robotic automation systems are used in manufacturing industries including, but not limited to, industries that produce goods (i.e., food, beverages, clothing, cosmetics, toiletries, etc.), medications, medical devices, healthcare supplies, furniture, sports equipment, toys, computers, consumer electronics, electrical equipment, heavy machinery, building materials, tools, chemicals, refined petroleum products, steel, ships, aircrafts, and automobiles. Robotic automation systems have been applied in these manufacturing industries to improve performance, productivity, and work quality.

One type of manufacturing is additive manufacturing. Additive manufacturing is the industrial production name for 3D printing. Additive manufacturing references technologies that grow three-dimensional objects one superfine layer at a time. Each successive layer bonds to the preceding layer of melted or partially melted material. Objects are digitally defined by computer-aided-design (CAD) software that is used to create .stl files that essentially “slice” the object into ultra-thin layers. This information guides the path of a nozzle or print head as it precisely deposits material upon the preceding layer. A laser or electron beam selectively melts or partially melts in a bed of powdered material. As materials cool or are cured, they fuse together to form the three-dimensional object. Thus, additive manufacturing allows for the formation of a three-dimensional object with a precise geometric shape that is built layer by layer, which is in contrast to traditional manufacturing that often requires machining or other techniques to remove surplus material. In regard to the use of photosensitive resin in additive manufacturing, a droplet jetting technology uses photosensitive resin to form a part and cures the photosensitive resin with an ultraviolet light.

### SUMMARY

Aspects of an embodiment of the present invention disclose a method, computer program product, and computer system for manufacturing a spare part with rapid speed. A processor identifies a spare part to be manufactured. A processor gathers a set of data regarding one or more properties of the spare part. A processor determines the spare part can be manufactured using a casting process based on the one or more properties of the spare part. A processor determines a photosensitive resin can be used to make a mold in which an individual part of the spare part will be manufactured. A processor creates an ultraviolet (UV) ray based holographic model of the individual part. A processor projects the UV ray based holographic model of the individual part on the photosensitive resin. A processor enables the photosensitive resin to solidify to create a mold of the individual part. A processor dynamically creates a production line to assemble one or more molds of one or more individual parts of the spare part.

In some aspects of an embodiment of the present invention, the one or more properties of the spare part includes at least one of a type of material required to be used to manufacture the spare part, a melting point of the type of material required to be used to manufacture the spare part, a quantity of volume of the type of material required to be used to manufacture the spare part, a size of the spare part, a shape of the spare part, a quantity of one or more different molds to be assembled to complete the manufacturing of the spare part, and a quantity of one or more steps to complete the manufacturing of the spare part.

In some aspects of an embodiment of the present invention, subsequent to determining the photosensitive resin can be used to make the mold in which the individual part of the spare part will be manufactured, a processor determines the casting process cannot be completed in one step from a set of historical information. A processor identifies a number of molds needed to complete the casting process.

In some aspects of an embodiment of the present invention, subsequent to identifying the number of molds needed to complete the casting process, a processor identifies one or more assembly steps required to be carried out after a completion of the casting process. A processor adds the one or more assembly steps required to be carried out after the completion of the casting process to an assembling sequence. A processor identifies the assembling sequence to assemble the one or more molds of the one or more individual parts of the spare part.

In some aspects of an embodiment of the present invention, subsequent to determining the photosensitive resin can be used to make the mold in which the individual part of the spare part will be manufactured, a processor identifies a counter shape to be considered as the mold in which the individual part of the spare part will be manufactured.

In some aspects of an embodiment of the present invention, a processor instructs a robotic system to place the mold in which the individual part will be manufactured on the production line. A processor instructs a casting module to pour a liquid material into the mold. A processor instructs the robotic system to remove the individual part from the production line after the liquid material solidifies.

In some aspects of an embodiment of the present invention, subsequent to dynamically creating the production line to assemble the one or more molds of the one or more individual parts of the spare part, a processor evaluates a quality of the mold of the individual part. A processor determines the mold of the individual part may be reused to manufacture a second individual part.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of a rapid production program, on a server within the distributed data processing environment of FIG. 1, in accordance with an embodiment of the present invention; and

FIG. 3 depicts a block diagram of components of a computing environment representing the distributed data processing environment of FIG. 1, in accordance with an embodiment of the present invention.

### DETAILED DESCRIPTION

Embodiments of the present invention recognize that additive manufacturing, or 3D printing, references technologies that grow three-dimensional objects one superfine layer at a time. Each successive layer bonds to the preceding layer of melted or partially melted material. The three-dimensional objects are digitally defined by computer-aided-design (CAD) software that is used to create .stl files that essentially “slice” the object into ultra-thin layers. This information guides the path of a nozzle or print head as it precisely deposits material upon the preceding layer. A laser or electron beam selectively melts or partially melts in a bed of powdered material. As materials cool or are cured, they fuse together to form the three-dimensional object.

Embodiments of the present invention recognize that spare parts of different types of machines require different types of material to be manufactured. Every spare part can't be manufactured with photosensitive resin. At the same time, additive manufacturing is very slow since the material must be laid layer-by-layer. Embodiments of the present invention recognize that casting is a much faster manufacturing process. Casting, however, cannot manufacture complex shapes, like additive manufacturing can. Therefore, embodiments of the present invention recognize the need for a system and method to manufacture less complex spare parts with rapid speed.

Embodiments of the present invention provide an artificially intelligent enabled system and method to manufacture less complex spare parts with rapid speed. Embodiments of the present invention also provide a hybrid method to manufacture comparatively more complex spare parts. Embodiments of the present invention provide an artificially intelligent enabled system and method that considers: a type of material required to be used in the manufacturing of a spare part (e.g., considering the melting point of the material); a shape and dimension of an object to be manufactured to validate if the same can be manufactured with casting; and a number of spare parts to be manufactured, or if rapid manufacturing is to be performed, to evaluate if a photosensitive resin can be used to make a mold rapidly for the spare parts to be manufactured. A mold is a negative form used to shape a liquid material to create a duplicate (in reverse) of an object. The object, for example, may be the spare parts to be manufactured. A mold may be concave, meaning the mold curves inward, or convex, meaning the mold sticks out. The shape of the mold is an important consideration in determining what the mold is made of and the resulting complexity of the mold. If the master shape is a three-dimensional shape, the master shape can be cast using either a single-sided mold or a double-sided mold. A single-sided mold is used when only one side of the finished cast piece will be visible. The visible side is the side cast against the surface of the mold. A double-sided mold uses an inner and outer mold, so both sides of the cast piece are finished and visible. Accordingly, the artificially intelligent enabled system and method analyzes the shape and dimension of the spare parts to be manufactured and creates an ultraviolet (UV) light based holographic model of the mold. This is referred to as molding or mold making. Molding or mold making is the act of creating a form that carries a negative or reverse impression of an original mold. Molds can be made of a rigid material, such as plaster or plastic resin or more commonly, a flexible material such as rubber. Casting, a manufacturing process, relies on molds. Casting is the act of pouring a liquid material into the form of a mold. After a period of time, the liquid material will cure via a chemical reaction or a cooling process. The solidified part, also known as a cast, is ejected or broken out of the mold to complete the process. The artificially intelligent enabled system analyzes the shape and dimension of the spare parts to be manufactured and determines if the photosensitive resin-based mold can be reused as is or if split molds are to be created, so that the casted object can be taken out without breaking the mold and the same can be reused. Accordingly, a UV light based holographic object creation module will split the holographic objects of the mold for rapid manufacturing of the mold. While the mold is created for casting of the spare parts, the artificially intelligent enabled system continues to evaluate the quality of the mold created by photosensitive resin after every casting process and evaluates how long the same mold can be used for casting and then recycling the photosensitive resin-based mold for a new mold creation. Based on the creation of the photosensitive resin-based mold, different types of steps are required to complete the casting process. The artificially intelligent enabled system dynamically creates a production line and aligns the speed of a mold creation module with a photosensitive resin and casting process, so that rapid manufacturing can be performed. The artificially intelligent enabled system evaluates which molds can be reused and which molds are to be recycled. Accordingly, the artificially intelligent enabled system enables a production line to run seamlessly, so that manufacturing of the spare parts can be performed rapidly.

Implementation of embodiments of the present invention may take a variety of forms, and exemplary implementation details are discussed subsequently with reference to the Figures.

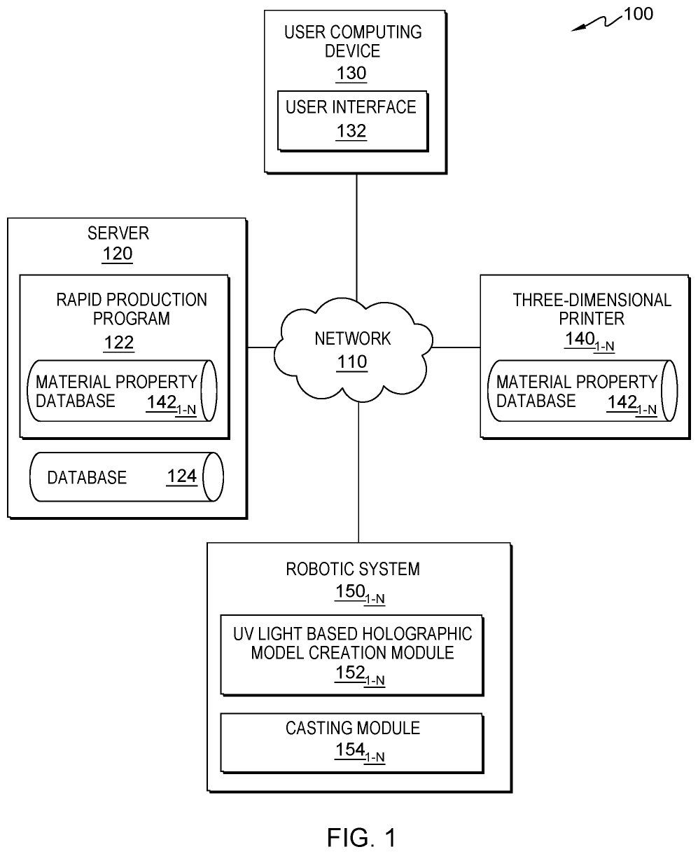

FIG. 1 is a block diagram illustrating a distributed data processing environment, generally designated 100, in accordance with an embodiment of the present invention. In the depicted embodiment, distributed data processing environment 100 includes server 120, user computing device 130, three-dimensional printer 140_{1-N}, and robotic system 150_{1-N}, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, three-dimensional printer 140_{1-N}, and robotic system 150_{1-N}, and other computing devices (not shown) within distributed data processing environment 100.

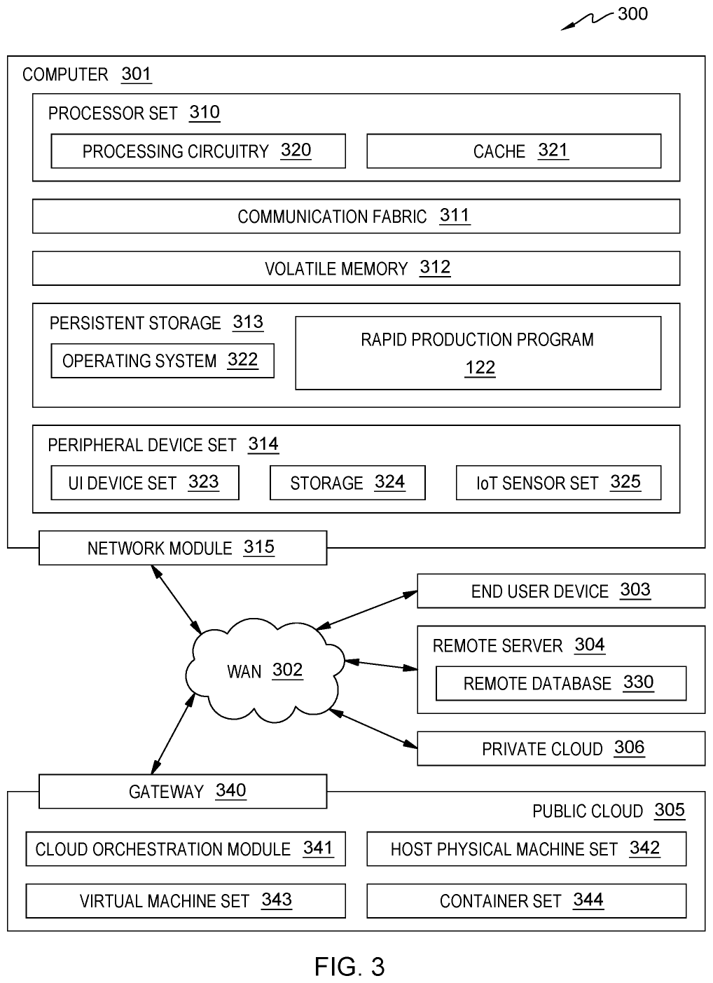

Server 120 operates to run rapid production program 122 and to send and/or store data in database 124 and material property database 142_{1-N}. In an embodiment, server 120 can send data from database 124 to user computing device 130, three-dimensional printer 140_{1-N}, and robotic system 150_{1-N}. In another embodiment, server 120 can send data from material property database 142_{1-N} to user computing device 130, three-dimensional printer 140_{1-N}, and robotic system 150_{1-N}. In an embodiment, server 120 can receive data in database 124 from user computing device 130, three-dimensional printer 140_{1-N}, and robotic system 150_{1-N}. In another embodiment, material property database 142_{1-N} can receive data in database 124 from user computing device 130, three-dimensional printer 140_{1-N}, and robotic system 150_{1-N}. In one or more embodiments, server 120 can be a standalone computing device, a management server, a web server, a mobile computing device, or any other electronic device or computing system capable of receiving, sending, and processing data and capable of communicating with user computing device 130, three-dimensional printer 140_{1-N}, and robotic system 150_{1-N} via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130, three-dimensional printer 140_{1-N}, and robotic system 150_{1-N} and other computing devices (not shown) within distributed data processing environment 100 via network 110. Server 120 may include internal and external hardware components, as depicted and described in further detail in FIG. 3.

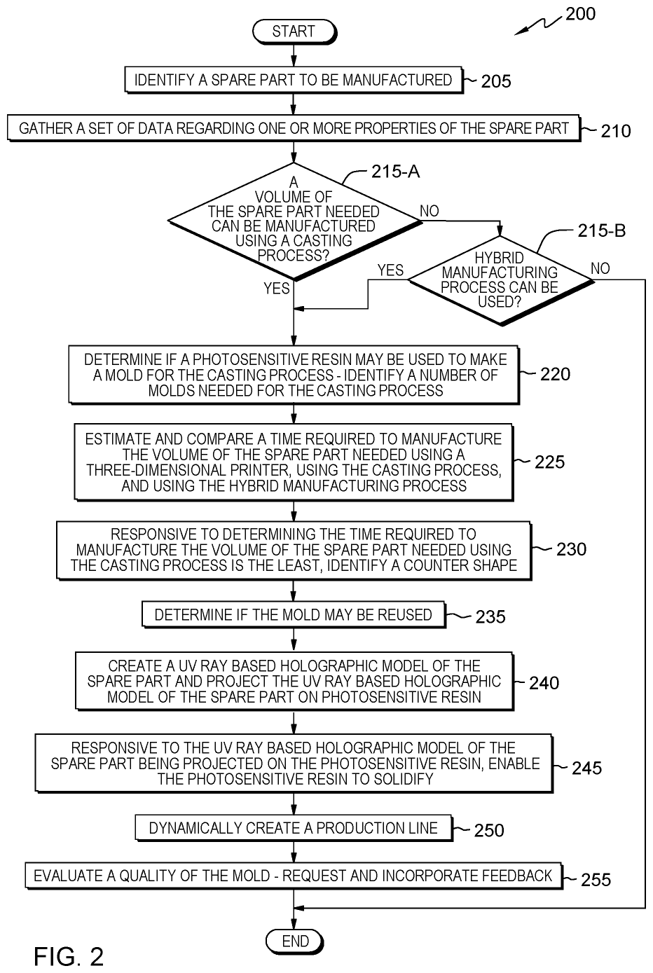

Rapid production program 122 operates to manufacture a less complex spare part with rapid speed. Additionally, rapid production program 122 operates to provide a hybrid method to manufacture a comparatively more complex spare part. In the depicted embodiment, rapid production program 122 is a standalone program. In another embodiment, rapid production program 122 may be integrated into another software product. In the depicted embodiment, rapid production program 122 resides on server 120. In another embodiment, rapid production program 122 may reside on another computing device (not shown), provided that rapid production program 122 has access to network 110. In the depicted embodiment, rapid production program 122 includes material property database 142_{1-N}. The operational steps of rapid production program 122 are depicted and described in further detail with respect to FIG. 2.

In an embodiment, the user of user computing device 130 registers with rapid production program 122 of server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via rapid production program 122). Relevant data includes, but is not limited to, personal information or data provided by the user; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Material property database 142_{1-N} operates to store a set of historical information regarding one or more spare parts. The set of historical information regarding the one or more spare parts may include, but is not limited to, a digital three-dimensional model of a spare part; one or more properties of a spare part (e.g., a type of material required to be used to manufacture a spare part, a property of the type of material required to be set and reached to manufacture a spare part (e.g., a melting point of the type of material), a proportion of a spare part (e.g., a shape and a size of a spare part), and a degree of complexity of manufacturing a spare part); and a historical definition of the casting process of a spare part or a similar spare part and a historical capability and/or a historical capacity of a manufacturing method used in the casting process of a spare part. As used herein, N represents a positive integer, and accordingly the number of scenarios implemented in a given embodiment of the present invention is not limited to those depicted in FIG. 1. In the depicted embodiment, material property database 142_{1-N} is located on server 120 and on three-dimensional printer 140_{1-N}. In another embodiment, material property database 142_{1-N} is located only on server 120. In another embodiment, material property database 142_{1-N} is located only on three-dimensional printer 140_{1-N}.

Database 124 operates as a repository for data received, used, and/or generated by rapid production program 122. A database is an organized collection of data. Data includes, but is not limited to, information about user preferences (e.g., general user system settings such as alert notifications for user computing device 130); information about alert notification preferences; a tracking spreadsheet of one or more spare parts to be manufactured; and any other data received, used, and/or generated by rapid production program 122.

Database 124 can be implemented with any type of device capable of storing data and configuration files that can be accessed and utilized by server 120, such as a hard disk drive, a database server, or a flash memory. In an embodiment, database 124 is accessed by rapid production program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that rapid production program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Rapid production program 122 enables the authorized and secure processing of personal data and/or confidential company data.

Rapid production program 122 provides informed consent, with notice of the collection of personal and/or confidential company data, allowing the user to opt-in or opt-out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Rapid production program 122 provides information regarding personal and/or confidential company data and the nature (e.g., type, scope, purpose, duration, etc.) of the processing. Rapid production program 122 provides the user with copies of stored personal and/or confidential company data. Rapid production program 122 allows the correction or completion of incorrect or incomplete personal and/or confidential company data. Rapid production program 122 allows for the immediate deletion of personal and/or confidential company data.

User computing device 130 operates to run user interface 132 through which a user can interact with rapid production program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with rapid production program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between rapid production program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from rapid production program 122 to a user via network 110. User interface 132 can also display or present alerts including information (such as graphics, text, and/or sound) sent from rapid production program 122 to a user via network 110. In an embodiment, user interface 132 can send and receive data (i.e., to and from rapid production program 122 via network 110, respectively). Through user interface 132, a user can opt-in to rapid production program 122; input information about the user; create a user profile; set user preferences and alert notification preferences; input a request to manufacture a spare part; receive a request for feedback; and input feedback.

A user preference is a setting that can be customized for a particular user. A set of default user preferences are assigned to each user of rapid production program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of rapid production program 122.

Three-dimensional printer 140_{1-N} operates to automatically print a three-dimensional object as instructed by rapid production program 122. As used herein, N represents a positive integer, and accordingly the number of scenarios implemented in a given embodiment of the present invention is not limited to those depicted in FIG. 1. In an embodiment, three-dimensional printer 140_{1-N} can receive data from server 120, user computing device 130, and/or robotic system 150_{1-N}. In an embodiment, three-dimensional printer 140_{1-N} can send data to server 120, user computing device 130, and/or robotic system 150_{1-N}. In the depicted embodiment, three-dimensional printer 140_{1-N} includes material property database 142_{1-N}.

Robotic system 150_{1-N} operates to perform several manufacturing applications, including, but not limited to, material handling, processing operations, and assembly and inspection. For example, robotic system 150_{1-N} may create a production line, select a mold, cast using the mold selected, remove the mold, merge the mold, and assemble a spare part. As used herein, N represents a positive integer, and accordingly the number of scenarios implemented in a given embodiment of the present invention is not limited to those depicted in FIG. 1. In an embodiment, robotic system 150_{1-N} can receive data from server 120, user computing device 130, and/or three-dimensional printer 140_{1-N}. In an embodiment, robotic system 150_{1-N} can send data to server 120, user computing device 130, and/or three-dimensional printer 140_{1-N}. In the depicted embodiment, robotic system 150_{1-N} includes UV light based holographic model creation module 152_{1-N} and casting module 154_{1-N}.

UV light based holographic model creation module 152_{1-N} operates to create a UV ray based holographic model of a spare part or an individual part of the spare part needed; to project the UV ray based holographic model of the spare part or the individual part of the spare part on a photosensitive resin; and to split a liquid material from the mold (i.e., after the liquid material solidifies, creating the spare part or the individual part of the spare part, separating the spare part or the individual part of the spare part from the mold without breaking the mold so that the mold may be reused. As used herein, N represents a positive integer, and accordingly the number of scenarios implemented in a given embodiment of the present invention is not limited to those depicted in FIG. 1. In the depicted embodiment, UV light based holographic model creation module 152_{1-N} is located on robotic system 150_{1-N}.

Casting module 154_{1-N} operates to pour a liquid material into a mold on a production line. As used herein, N represents a positive integer, and accordingly the number of scenarios implemented in a given embodiment of the present invention is not limited to those depicted in FIG. 1. In the depicted embodiment, casting module 154_{1-N}is located on robotic system 150_{1-N}.

FIG. 2 is a flowchart, generally designated 200, illustrating the operational steps for rapid production program 122, on server 120 within distributed data processing environment 100 of FIG. 1, in accordance with an embodiment of the present invention. In an embodiment, rapid production program 122 operates to manufacture a less complex spare part with rapid speed. In an embodiment, rapid production program 122 further operates to provide a hybrid method to manufacture a comparatively more complex spare part. It should be appreciated that the process depicted in FIG. 2 illustrates one possible iteration of the process flow, which may be performed once for each spare part to be manufactured. Subsequent to a completion of a casting process, a visual inspection may be performed to evaluate a quality of a mold to determine if a defect exists and to determine if the mold can be reused. If a defect exists, the mold is corrected and/or recycled.

In step 205, rapid production program 122 identifies a spare part to be manufactured. In an embodiment, rapid production program 122 identifies a spare part to be manufactured from a tracking spreadsheet. The tracking spreadsheet may contain, but is not limited to, one or more spare parts to be manufactured. The tracking spreadsheet is stored in a first database (e.g., database 124) and is regularly updated. In another embodiment, rapid production program 122 receives a request to manufacture a spare part from a user (i.e., via a user interface (e.g., user interface 132) of a user computing device (e.g., user computing device 130)). In an embodiment, rapid production program 122 receives a digital three-dimensional model of the spare part to be manufactured. In an embodiment, rapid production program 122 receives a digital three-dimensional model of the spare part from a second database (e.g., a database storing a set of historical information regarding the spare part, e.g., material property database 142_{1-N}).

In step 210, rapid production program 122 gathers a set of data regarding one or more properties of the spare part. The set of data regarding the one or more properties of the spare part may include, but is not limited to, a type of material required to be used to manufacture the spare part, a property of the type of material required to be reached to manufacture the spare part (e.g., a melting point of the type of material), a volume of the type of material required to manufacture the spare part, a proportion of the spare part (e.g., a shape and a size of the spare part), and a degree of complexity of manufacturing the spare part. The degree of complexity of manufacturing the spare part is based on one or more factors. The one or more factors may include, but are not limited to, a quantity of one or more individual parts making up the spare part, a quantity of one or more molds to be molds to be made, and a quantity of one or more steps to complete the manufacturing of the spare part. In an embodiment, rapid production program 122 gathers a set of data regarding one or more properties of the spare part from a second database (e.g., a database storing a set of historical information regarding the spare part, e.g., material property database 142_{1-N}). In another embodiment, rapid production program 122 gathers a set of data regarding one or more properties of the spare part not available in a second database (e.g., a database storing a set of historical information regarding the spare part, e.g., material property database 142_{1-N}) from the user (i.e., via a user interface (e.g., user interface 132) of a user computing device (e.g., user computing device 130)). In an embodiment, rapid production program 122 gathers a set of data regarding one or more properties of the spare part to determine if the spare part can be manufactured using a casting process. In an embodiment, if the spare part cannot be manufactured using the casting process, a hybrid manufacturing process may be used to manufacture the spare part. The casting process involves an act of pouring liquid material into a mold. After a pre-set period of time, the liquid material cures via a chemical reaction or a cooling process. The solidified part, also known as a cast, is ejected or broken out of the mold. In some cases, the solidified part is the spare part. In other cases, the solidified part is an individual part of the spare part and is assembled with one or more additional individual parts to produce the spare part. The hybrid manufacturing process involves both the casting process and additive manufacturing. For example, the casting process may produce a first individual part of a spare part and additive manufacturing may produce a second individual part of the spare part. The first individual part and the second individual part are then assembled to produce the spare part. Additive manufacturing technologies grow a three-dimensional object one superfine layer at a time. Each successive layer bonds to the preceding layer of melted or partially melted material. The three-dimensional object is digitally defined by computer-aided-design (CAD) software that is used to create .stl files that essentially “slice” the object into ultra-thin layers. This information guides the path of a nozzle or print head as it precisely deposits material upon the preceding layer. A laser or electron beam selectively melts or partially melts a bed of powdered material. As the material cools or is cured, the material fuses to the proceeding layer to form the three-dimensional object. In some cases, the three-dimensional object is the spare part. In other cases, the three-dimensional object is an individual part of the spare part and is assembled with one or more additional individual parts to produce the spare part. In an embodiment, rapid production program 122 identifies a type of material required to be used to manufacture the spare part from the set of data gathered. In an embodiment, rapid production program 122 identifies a property of the type of material required to be set and reached to manufacture the spare part from the set of data gathered. In an embodiment, rapid production program 122 identifies a proportion of the spare part (e.g., a shape and a size of the spare part) from the set of data gathered. In an embodiment, rapid production program 122 identifies a degree of complexity of manufacturing the spare part from the set of data gathered.

In step 215-A, rapid production program 122 identifies a volume (i.e., quantity) of the spare part needed. The volume of the spare part needed may include, but is not limited to, a total number of the spare part needed to be manufactured (e.g., user A needs to manufacture 15 of spare part B), a total number of individual parts making up a spare part (e.g., spare part B is composed of 5 individual parts, part C, part D, part E, part F, and part G), a total number of the individual parts making up the spare part needed to be manufactured (e.g., 75 individual parts need to be manufactured (i.e., 15 of part C, 15 of part D, 15 of part E, 15 of part F, and 15 of part G)), and a total volume of material needed to manufacture each individual part of the spare part or the spare part. In an embodiment, rapid production program 122 identifies a volume of the spare part needed from the tracking spreadsheet (i.e., stored in the first database (e.g., database 124). In an embodiment, rapid production program 122 determines if the volume of the spare part needed may be manufactured using the casting process. In an embodiment, responsive to determining the volume of the spare part needed may be manufactured using the casting process (decision step 215-A, YES branch), rapid production program 122 proceeds to step 220, evaluating if a photosensitive resin may be used to rapidly make a mold to be used in the casting process. In an embodiment, responsive to determining the volume of the spare part needed may not be manufactured using the casting process (decision step 215-A, NO branch), rapid production program 122 proceeds to step 215-B, determining if a hybrid manufacturing process may be used to manufacture the volume of the spare part needed.

In decision step 215-B, rapid production program 122 determines if a hybrid manufacturing process may be used to manufacture the volume of the spare part needed. In an embodiment, responsive to determining a hybrid manufacturing process may be used to manufacture the volume of the spare part needed (decision step 215-B, YES branch), then rapid production program 122 proceeds to step 220, evaluating if a photosensitive resin may be used to rapidly make a mold to be used in the casting process. In an embodiment, responsive to determining a hybrid manufacturing process may not be used to manufacture the volume of the spare part needed (decision step 215-B, NO branch), then rapid production program 122 ends.

In step 220, rapid production program 122 evaluates if a photosensitive resin may be used to rapidly make a mold for the casting process. In an embodiment, rapid production program 122 evaluates if a photosensitive resin may be used to rapidly make a mold for the casting process based on the set of data gathered regarding the one or more properties of the spare part. The set of data gathered regarding the one or more properties of the spare part may include, but is not limited to, a type of material required to be used to manufacture the spare part, a property of the type of material required to be reached to manufacture the spare part (e.g., a melting point of the type of material), a quantity of the type of material required, a proportion of the spare part (e.g., a shape and a size of the spare part), and a degree of complexity of manufacturing the spare part. In an embodiment, responsive to determining a photosensitive resin may be used to rapidly make the mold for the casting process, rapid production program 122 identifies a number of molds needed for the casting process. In an embodiment, rapid production program 122 identifies a number of molds needed for the casting process by determining if the casting process may be completed in a single step. A single step process requires a single mold, whereas a multi-step process requires multiple molds. In an embodiment, rapid production program 122 determines if the casting process may be completed in a single step from a set of historical information regarding the spare part stored in the second database (e.g., material property database 142_{1-N}). The set of historical information regarding the spare part may include, but is not limited to, a historical definition of the casting process of the spare part or a similar spare part and a historical capability and/or a historical capacity of a manufacturing method used in the casting process of the spare part. In an embodiment, rapid production program 122 estimates a time required to make the number of molds needed for the casting process. In an embodiment, rapid production program 122 identifies an amount of time required for the material to solidify (i.e., a solidification time) after the completion of the casting process. In an embodiment, rapid production program 122 identifies if any additional assembly steps are required to be carried out after the completion of the casting process. In an embodiment, responsive to identifying an additional assembly step required to be carried out after the completion of the casting process, rapid production program 122 adds the additional assembly step to a sequence of assembly. In an embodiment, rapid production program 122 identifies a sequence of assembly to manufacture the spare part. In an embodiment, rapid production program 122 identifies a number of steps in the sequence of assembly.

In step 225, rapid production program 122 estimates a time required to three-dimensionally print the volume of the spare part needed using a three-dimensional printer (e.g., three-dimensional printer 140_{1-N}). In an embodiment, rapid production program 122 estimates a time required to manufacture the volume of the spare part needed using the casting process. In an embodiment, rapid production program 122 estimates a time required to manufacture the volume of the spare part needed using the hybrid manufacturing process. In an embodiment, rapid production program 122 compares the time estimated to three-dimensionally print the volume of the spare part needed to be manufactured, the time estimated to manufacture the volume of the spare part needed using the casting process (if applicable), and the time estimated to manufacture the volume of the spare part needed using the hybrid manufacturing process (if applicable).

In step 230, responsive to determining the time estimated to manufacture the volume of the spare part needed using the casting process (or the time estimated to manufacture the volume of the spare part needed using the hybrid manufacturing process) is less than the time estimated to three-dimensionally print the volume of the spare part needed, rapid production program 122 identifies a counter shape (i.e., a negative form, or mold, used to shape a liquid casting material to create a duplicate of the spare part). In an embodiment, rapid production program 122 identifies a counter shape to be considered as the mold of the spare part. In another embodiment, rapid production program 122 identifies one or more counter shapes to be considered as one or more molds of one or more individual parts of the spare part. In an embodiment, rapid production program 122 identifies a counter shape based on the proportion of the spare part (e.g., a shape and a size of the spare part).

In step 235, rapid production program 122 determines if a mold may be reused during the casting process (i.e., reused vs. needs to be broken and replaced). In an embodiment, rapid production program 122 determines if a mold may be reused during the casting process based on the proportion of the spare part (e.g., a shape and a size of the spare part).

In step 240, rapid production program 122 identifies a number of ultraviolet (UV) ray based holographic models needed to be created. In an embodiment, if a spare part is made up of one or more individual parts, rapid production program 122 identifies a number of UV ray based holographic models of the one or more individual parts of the spare part needed to be created. The number of UV ray based holographic models needed is equivalent to the one or more individual parts making up the spare part. An UV ray based holographic model may be created for each individual part of the one or more individual parts making up the spare part. In an embodiment, rapid production program 122 creates the number of UV ray based holographic models needed. In an embodiment, rapid production program 122 creates the number of UV ray based holographic models needed using a UV light based holographic model creation module (e.g., UV light based holographic model creation module 152_{1-N}). In an embodiment, rapid production program 122 creates an UV ray based holographic model based on the shape and the size of the mold to be used during the casting process. In an embodiment, rapid production program 122 projects the UV ray based holographic model on the photosensitive resin. In an embodiment, rapid production program 122 projects the UV ray based holographic model on the photosensitive resin using a UV light based holographic model creation module (e.g., UV light based holographic model creation module 152_{1-N}).

In step 245, subsequent to projecting the UV ray based holographic model on the photosensitive resin, rapid production program 122 enables the photosensitive resin to solidify. In an embodiment, rapid production program 122 creates a mold of the spare part. In an embodiment, rapid production program 122 creates a mold of each individual part of the one or more individual parts making up the spare part.

In step 250, rapid production program 122 dynamically creates a production line. In an embodiment, rapid production program 122 dynamically creates a production line to rapidly manufacture the spare part. In an embodiment, rapid production program 122 dynamically creates a production line using a robotic system (e.g., robotic system 150_{1-N}). In an embodiment, rapid production program 122 instructs the robotic system (e.g., robotic system 150_{1-N}) to pick a mold created after the photosensitive resin has solidified. In an embodiment, rapid production program 122 instructs the robotic system (e.g., robotic system 150_{1-N}) to place the mold on the production line. In an embodiment, rapid production program 122 instructs a casting module (e.g., casting module 154_{1-N} of robotic system 150_{1-N}) to pour a liquid material into the mold on the production line. In an embodiment, rapid production program 122 splits the liquid material from the mold (i.e., after the liquid material solidifies, creating the spare part and separating the spare part from the mold without breaking the mold so that the mold may be reused). In an embodiment, rapid production program 122 splits the liquid material from the mold using a UV light based holographic model creation module (e.g., UV light based holographic model creation module 152_{1-N}). In an embodiment, rapid production program 122 instructs the robotic system (e.g., robotic system 150_{1-N}) to remove the spare part created from the production line (i.e., after the liquid material solidifies). In an embodiment, rapid production program 122 instructs the robotic system (e.g., robotic system 150_{1-N}) to perform any remaining steps to complete the manufacturing of the spare part. In an embodiment, if a spare part is made up of one or more individual parts, rapid production program 122 instructs the robotic system (e.g., robotic system 150_{1-N}) to assemble the one or more individual parts of the spare part.

In step 255, rapid production program 122 evaluates a quality of the mold. In an embodiment, rapid production program 122 evaluates a quality of the mold based on whether the spare part was properly manufactured (e.g., whether the spare part operates properly and whether the spare part has any defects). In an embodiment, rapid production program 122 evaluates a quality of the mold based on whether the mold was broken to release the spare part (i.e., whether the mold can be reused as is or, if a split mold was created, whether the mold should be recycled). In an embodiment, rapid production program 122 determines whether the mold can be reused as is or, if a split mold was created, whether the mold should be recycled. In an embodiment, rapid production program 122 outputs a request for feedback to the user. The feedback requested may include, but is not limited to, feedback on a quality of the mold created, feedback on a quality of the production line created, feedback on a quality of the spare part created, and any other feedback offered and received regarding an iteration of a process flow of rapid production program 122. In an embodiment, rapid production program 122 outputs a request for feedback to the user via a user computing device (e.g., user computing device 130). In an embodiment, rapid production program 122 enables the user to input feedback via a user interface (e.g., user interface 132) of a user computing device (e.g., user computing device 130). In an embodiment, rapid production program 122 receives the feedback input by the user. In an embodiment, rapid production program 122 processes the feedback input by the user. In an embodiment, rapid production program 122 incorporates the feedback to improve a future iteration of the process flow.

FIG. 3 depicts a block diagram of components of server 120 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as rapid production program 122. In addition to rapid production program 122, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and rapid production program 122, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in rapid production program 122 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in rapid production program 122 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
identifying, by one or more processors, a spare part to be manufactured;
gathering, by the one or more processors, a set of data regarding one or more properties of the spare part;
determining, by the one or more processors, the spare part can be manufactured using a casting process based on the one or more properties of the spare part, wherein the step of determining further comprises:
determining, by the one or more processors, a photosensitive resin can be used to make a mold in which an individual part of the spare part will be manufactured;
creating, by the one or more processors, an ultraviolet (UV) ray based holographic model of the individual part;
projecting, by the one or more processors, the UV ray based holographic model of the individual part on the photosensitive resin; and
enabling, by the one or more processors, the photosensitive resin to solidify to create a mold of the individual part; and
dynamically creating, by the one or more processors, a production line to assemble one or more molds of one or more individual parts of the spare part.

2. The computer-implemented method of claim 1, wherein the one or more properties of the spare part includes at least one of a type of material required to be used to manufacture the spare part, a melting point of the type of material required to be used to manufacture the spare part, a quantity of volume of the type of material required to be used to manufacture the spare part, a size of the spare part, a shape of the spare part, a quantity of one or more different molds to be assembled to complete the manufacturing of the spare part, and a quantity of one or more steps to complete the manufacturing of the spare part.

3. The computer-implemented method of claim 1, further comprises:
subsequent to determining the photosensitive resin can be used to make the mold in which the individual part of the spare part will be manufactured, determining, by the one or more processors, the casting process cannot be completed in one step from a set of historical information; and
identifying, by the one or more processors, a number of molds needed to complete the casting process.

4. The computer-implemented method of claim 3, further comprising:
subsequent to identifying the number of molds needed to complete the casting process, identifying, by the one or more processors, one or more assembly steps required to be carried out after a completion of the casting process;
adding, by the one or more processors, the one or more assembly steps required to be carried out after the completion of the casting process to an assembling sequence; and
identifying, by the one or more processors, the assembling sequence to assemble the one or more molds of the one or more individual parts of the spare part.

5. The computer-implemented method of claim 1, further comprising:
subsequent to determining the photosensitive resin can be used to make the mold in which the individual part of the spare part will be manufactured, identifying, by the one or more processors, a counter shape to be considered as the mold in which the individual part of the spare part will be manufactured.

6. The computer-implemented method of claim 1, wherein dynamically creating the production line to assemble the one or more molds of the one or more individual parts of the spare part further comprises:
instructing, by the one or more processors, a robotic system to place the mold in which the individual part will be manufactured on the production line;
instructing, by the one or more processors, a casting module to pour a liquid material into the mold;
instructing, by the one or more processors, the robotic system to remove the individual part from the production line after the liquid material solidifies.

7. The computer-implemented method of claim 1, further comprising:
subsequent to dynamically creating the production line to assemble the one or more molds of the one or more individual parts of the spare part, evaluating, by the one or more processors, a quality of the mold of the individual part; and
determining, by the one or more processors, the mold of the individual part may be reused to manufacture a second individual part.

8. A computer program product comprising:
one or more computer readable storage media and program instructions stored on the one or more computer readable storage media, the program instructions comprising:
program instructions to identify a spare part to be manufactured;
program instructions to gather a set of data regarding one or more properties of the spare part;
program instructions to determine the spare part can be manufactured using a casting process based on the one or more properties of the spare part, wherein the step of determining further comprises:
program instructions to determine a photosensitive resin can be used to make a mold in which an individual part of the spare part will be manufactured;
program instructions to create an ultraviolet (UV) ray based holographic model of the individual part;
program instructions to project the UV ray based holographic model of the individual part on the photosensitive resin; and
program instructions to enable the photosensitive resin to solidify to create a mold of the individual part; and
program instructions to dynamically create a production line to assemble one or more molds of one or more individual parts of the spare part.

9. The computer program product of claim 8, wherein the one or more properties of the spare part includes at least one of a type of material required to be used to manufacture the spare part, a melting point of the type of material required to be used to manufacture the spare part, a quantity of volume of the type of material required to be used to manufacture the spare part, a size of the spare part, a shape of the spare part, a quantity of one or more different molds to be assembled to complete the manufacturing of the spare part, and a quantity of one or more steps to complete the manufacturing of the spare part.

10. The computer program product of claim 8, further comprises:
subsequent to determining the photosensitive resin can be used to make the mold in which the individual part of the spare part will be manufactured, program instructions to determine the casting process cannot be completed in one step from a set of historical information; and
program instructions to identify a number of molds needed to complete the casting process.

11. The computer program product of claim 10, further comprising:
subsequent to identifying the number of molds needed to complete the casting process, program instructions to identify one or more assembly steps required to be carried out after a completion of the casting process;
program instructions to add the one or more assembly steps required to be carried out after the completion of the casting process to an assembling sequence; and
program instructions to identify the assembling sequence to assemble the one or more molds of the one or more individual parts of the spare part.

12. The computer program product of claim 8, further comprising:
subsequent to determining the photosensitive resin can be used to make the mold in which the individual part of the spare part will be manufactured, program instructions to identify a counter shape to be considered as the mold in which the individual part of the spare part will be manufactured.

13. The computer program product of claim 8, wherein dynamically creating the production line to assemble the one or more molds of the one or more individual parts of the spare part further comprises:
program instructions to instruct a robotic system to place the mold in which the individual part will be manufactured on the production line;
program instructions to instruct a casting module to pour a liquid material into the mold;
program instructions to instruct the robotic system to remove the individual part from the production line after the liquid material solidifies.

14. The computer program product of claim 8, further comprising:
subsequent to dynamically creating the production line to assemble the one or more molds of the one or more individual parts of the spare part, program instructions to evaluate a quality of the mold of the individual part; and
program instructions to determine the mold of the individual part may be reused to manufacture a second individual part.

15. A computer system comprising:
one or more computer processors;
one or more computer readable storage media;
program instructions collectively stored on the one or more computer readable storage media for execution by at least one of the one or more computer processors, the stored program instructions comprising:
program instructions to identify a spare part to be manufactured;
program instructions to gather a set of data regarding one or more properties of the spare part;
program instructions to determine the spare part can be manufactured using a casting process based on the one or more properties of the spare part, wherein the step of determining further comprises:
program instructions to determine a photosensitive resin can be used to make a mold in which an individual part of the spare part will be manufactured;
program instructions to create an ultraviolet (UV) ray based holographic model of the individual part;
program instructions to project the UV ray based holographic model of the individual part on the photosensitive resin; and
program instructions to enable the photosensitive resin to solidify to create a mold of the individual part; and
program instructions to dynamically create a production line to assemble one or more molds of one or more individual parts of the spare part.

16. The computer system of claim 15, wherein the one or more properties of the spare part includes at least one of a type of material required to be used to manufacture the spare part, a melting point of the type of material required to be used to manufacture the spare part, a quantity of volume of the type of material required to be used to manufacture the spare part, a size of the spare part, a shape of the spare part, a quantity of one or more different molds to be assembled to complete the manufacturing of the spare part, and a quantity of one or more steps to complete the manufacturing of the spare part.

17. The computer system of claim 15, further comprises:
subsequent to determining the photosensitive resin can be used to make the mold in which the individual part of the spare part will be manufactured, program instructions to determine the casting process cannot be completed in one step from a set of historical information; and
program instructions to identify a number of molds needed to complete the casting process.

18. The computer system of claim 17, further comprising:
subsequent to identifying the number of molds needed to complete the casting process, program instructions to identify one or more assembly steps required to be carried out after a completion of the casting process;
program instructions to add the one or more assembly steps required to be carried out after the completion of the casting process to an assembling sequence; and
program instructions to identify the assembling sequence to assemble the one or more molds of the one or more individual parts of the spare part.

19. The computer system of claim 15, wherein dynamically creating the production line to assemble the one or more molds of the one or more individual parts of the spare part further comprises:
program instructions to instruct a robotic system to place the mold in which the individual part will be manufactured on the production line;
program instructions to instruct a casting module to pour a liquid material into the mold;
program instructions to instruct the robotic system to remove the individual part from the production line after the liquid material solidifies.

20. The computer system of claim 15, further comprising:
subsequent to dynamically creating the production line to assemble the one or more molds of the one or more individual parts of the spare part, program instructions to evaluate a quality of the mold of the individual part; and
program instructions to determine the mold of the individual part may be reused to manufacture a second individual part.
